(19) United States
(12) Patent Application Publication
(10) Pub. No.: US 2021/0004885 A1
(43) Pub. Date: Jan. 7, 2021

(54) AUTOMATED EVALUATION OF HUMAN-COMPUTER INTERACTION VIA CONVERSATIONAL COMPUTING

(71) Applicant: International Business Machines Corporation, Armonk, NY (US)

(72) Inventors: Roy Abitbol, Zurit (IL); Eliezer Wasserkrug, Haifa (IL); Asaf Adi, Kiryat Ata (IL)

(21) Appl. No.: 16/459,623

(22) Filed: Jul. 2, 2019

(51) Int. Cl. G06Q 30/06; G06N 3/08

(52) U.S. Cl. CPC G06Q 30/0613; G06N 3/084; G06Q 30/0635

(57) ABSTRACT

A method comprising: accessing one or more conversational flows of a conversational computer program, wherein the one or more conversational flows each comprises dialogue nodes and fulfillment nodes, and wherein each of the one or more conversational flows is at least one of: (a) a historical conversational flow of a human-computer conversation carried out by the conversational computer program, and (b) a programmed conversational flow, according to which the conversational computer program conducts human-computer conversations; receiving a desirability score of each of at least some of the fulfillment nodes; and based on the one or more conversational flows and the desirability scores, automatically assigning a polarity score to each of at least some of the dialogue nodes.

### BACKGROUND

The invention relates to the field of conversational computing.

Conversational computing is a style of human-computer interaction where users have a conversation with a computer program via a text or voice chat, in lieu of operating a GUI (Graphical User Interface) or typing syntaxed commands.

Two of the most common types of conversational computing programs are virtual assistants (such as Ski by Apple, Inc., Google Assistant by Google LLC, and Alexa by Amazon.com, Inc.) and chatbots (such as Watson Assistant by IBM Corp., and Azure Bot Service by Microsoft Corp.). Conversational computing relies heavily on technologies like natural language processing (NLP) and artificial intelligence (AI).

Conversational computing is increasingly common in customer service, technical support, shopping, and booking travel arrangements, where computers begin to replace human service providers in fulfilling customer needs.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

One embodiment relates to a method that comprises using at least one hardware processor for: accessing one or more conversational flows of a conversational computer program, wherein the one or more conversational flows each comprises dialogue nodes and fulfillment nodes, and wherein each of the one or more conversational flows is at least one of: (a) a historical conversational flow of a human-computer conversation carried out by the conversational computer program, and (b) a programmed conversational flow, according to which the conversational computer program conducts human-computer conversations; receiving a desirability score of each of at least some of the fulfillment nodes; and based on the one or more conversational flows and the desirability scores, automatically assigning a polarity score to each of at least some of the dialogue nodes.

In some embodiments, the fulfillment nodes represent certain actions fulfilled outside of the conversational computer program; and the dialogue nodes represent messages between the computer and a human user of the computer, wherein the messages do not include said fulfilled certain actions.

In some embodiments, the certain actions outside of the conversational computer program are selected from the group consisting of: adding or removing an item to an e-commerce shopping cart on behalf of the user; and completing an e-commerce purchase on behalf of the user.

In some embodiments, the desirability score is a numerical of textual value representative of a range from desirable to undesirable.

In some embodiments, the polarity scores are numerical or textual values representative of a range from positive to negative.

In some embodiments, the automatic assignment of the polarity scores includes backpropagating the desirability score of each of at least some of the fulfillment nodes to one or more of the dialogue nodes that precede that fulfillment node.

In some embodiments, the method further comprises: obtaining additional historical data of multiple human-computer conversations carried out by the conversational computer program; and updating the polarity scores of at least some of the dialogue nodes based on probable paths of conversation learned from the additional historical data.

In some embodiments, the method further comprises: altering an order of a planned conversational flow of the conversational computer program, based on at least one of: the desirability scores, and the polarity scores; and executing the conversational computer program to automatically converse with a human user based on the altered order of the planned conversational flow.

In some embodiments, said at least one of (a) and (b) is: (a) and (b).

Another embodiment relates to a system that comprises: at least one hardware processor; and a non-transitory computer-readable storage medium having program instructions stored thereon, the program instructions executable by said at least one hardware processor to perform the actions of one or more of the above embodiments of the method.

A further embodiment relates to a computer program product comprising a non-transitory computer-readable storage medium having program instructions embodied therewith, the program instructions executable by at least one hardware processor to perform the actions of one or more of the above embodiments of the method.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a block diagram of an exemplary system for automated evaluation of human-computer conversations, according to an embodiment;

FIG. 2 is a flow chart of a method for automated evaluation of human-computer conversations, according to an embodiment;

FIG. 3 is an exemplary directed graph representative of a conversational flow, according to an embodiment; and

FIG. 4 is an exemplary scored directed graph representative of a conversational flow, according to an embodiment.

### DETAILED DESCRIPTION

Disclosed herein is a method, system, and computer program product for automatically analyzing conversations carried out between conversational computer programs and humans, to evaluate the business value of conversations and/or to identify and correct undesirable conversational flows.

The term “conversational computer program,” as used herein, refers to a computer program configured to automatically and autonomously hold a conversation with a human user, such as via text messaging (e.g., a “chat bot”) or voice chat. The conversational computer program may be configured with a directed graph that defines a ‘conversational flow’—the flow of all (or most) possible conversations between the computer and the human. The directed graph may include nodes and directed edges connecting various ones of the nodes. Nodes may be either dialogue nodes or fulfillment nodes. Dialogue nodes represent messages between the computer and the human, and the edges between them instruct the conversational computer program what message to send next, based on a preceding node that represents a human message. Fulfillment nodes represent certain actions outside of the conversational computer program that have been fulfilled by the conversational computer program. Reports of these action may or may not be sent to the human as messages, considered ‘dialogue’ nodes (but the fulfillment itself is not regarded herein as a ‘dialogue’ node). The fulfilled actions may include, for example, adding an item to an e-commerce shopping cart on behalf of the user, or completing an e-commerce purchase on behalf of the user—all performed by the conversational computer program communicating, automatically, with external computing resources. Such communications may take place over a network, such as the Internet.

To analyze the computer-human conversations, the conversational computer program may be accessed, for example, through an API (Application Program Interface) thereof. The API may receive and respond to various queries (also ‘commands’), such as queries to retrieve the conversational flow or parts thereof, or to retrieve historical data of multiple human-computer conversations carried out previously by the conversational computer program.

In addition to retrieving the conversational flow (namely, its dialogue nodes and fulfillment nodes) and the historical data, also received is a desirability score of each of at least some of the fulfillment nodes. The desirability score may be a numerical of textual value representative of a range from desirable to undesirable. Merely as an example, that score may be ‘desirable,’ ‘undesirable,’ or ‘neutral.’ This scoring may be performed manually by an administrator of the conversational computer program, for example based on a perceived business value of each fulfilled action. For instance, the administrator may define that the desirability score for a node of completing an e-commerce is ‘desirable,’ whereas the desirability score for a node of removing an item from an e-commerce shopping cart is ‘undesirable.’

Then, based on the historical data and the desirability scores of the fulfillment nodes, a polarity score may automatically be assigned to each of at least some of the dialogue nodes. The polarity scores are numerical or textual values representative of a range from positive to negative (merely for example, 1, 0, and −1). This automatic assignment of scores to dialogue nodes is highly advantageous, because it spares the need to manually review and score each and every one of the numerous dialogue nodes existing in a typical conversational computer program. By the present technique, manual scoring is only required for fulfillment nodes, which are typically very few in the typical conversational computer program, and are also much easier to assign a business value to.

Moreover, by statistically analyzing large amounts of historical data of the conversational computer program, probable paths of conversation towards desirable, undesirable, and neutral fulfillment nodes may be learned, automatically. The polarity scores of the dialogue nodes may then be updated based on the learned probable paths, under the premise that dialogue nodes that lead more often to a certain type of fulfillment node (e.g., desirable, undesirable, neutral) should be scored accordingly with this tendency.

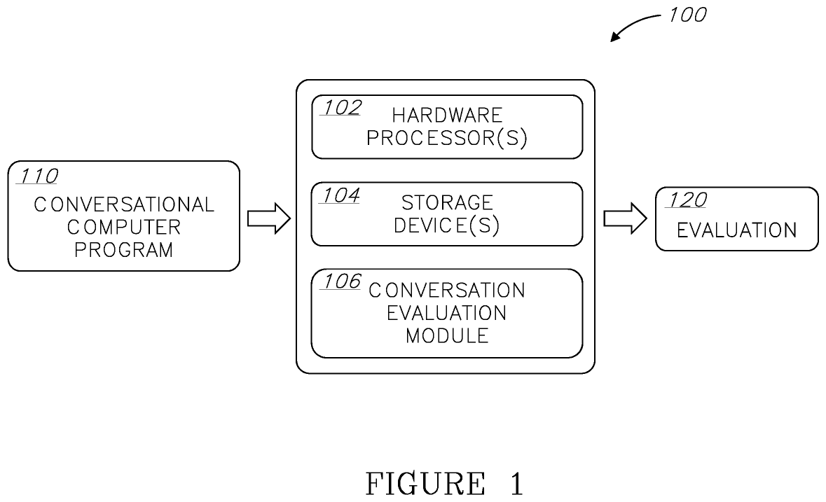

Reference is now made to FIG. 1, which shows a block diagram of an exemplary system 100 for automated evaluation of human-computer conversations, according to an embodiment. System 100 may comprise one or more hardware processors 102, and a non-transitory computer-readable storage device 104. System 100 as described herein is only an exemplary embodiment of the present invention, and in practice may be implemented in hardware only, software only, or a combination of both hardware and software. System 100 may have more or fewer components and modules than shown, may combine two or more of the components, or may have a different configuration or arrangement of the components. In various embodiments, system 100 may comprise one or more dedicated hardware devices, one or more software modules, and/or may form an addition to or extension to an existing device.

Storage medium 104 may have encoded thereon software instructions or components configured to operate a processing unit (also “hardware processor,” “CPU,” or simply “processor”), such as hardware processor(s) 102. In some embodiments, the software components may include an operating system, including various software components and/or drivers for controlling and managing general system tasks (e.g., memory management, storage device control, power management, etc.), and facilitating communication between various hardware and software components. In some embodiments, the program instructions are segmented into one or more software modules, which may comprise, e.g., a conversation evaluation module 106.

System 100 may receive information from or relating to a conversational computer program 110, evaluate that information, and output the evaluation 120.

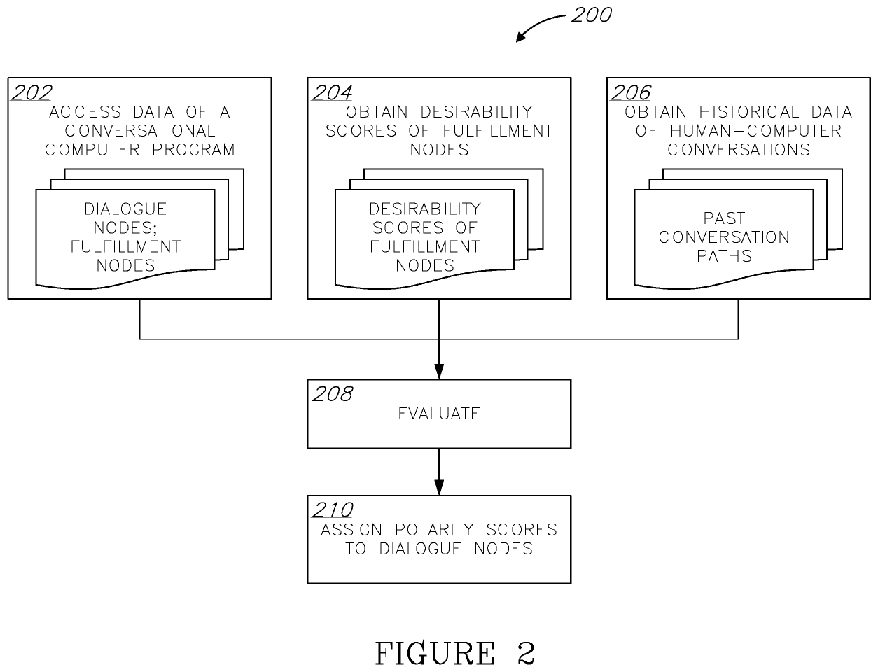

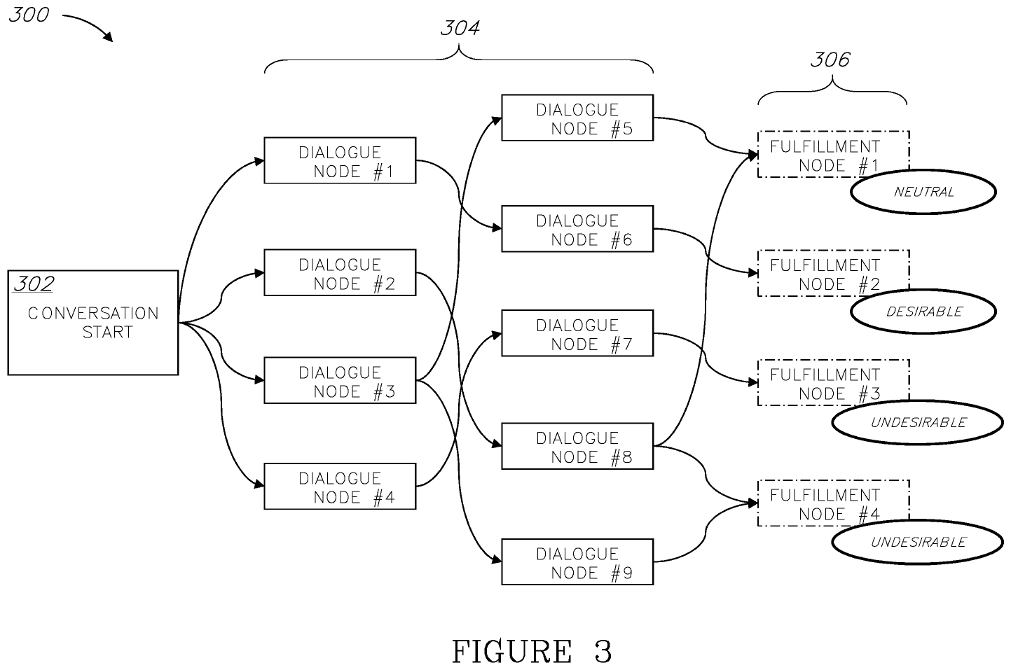

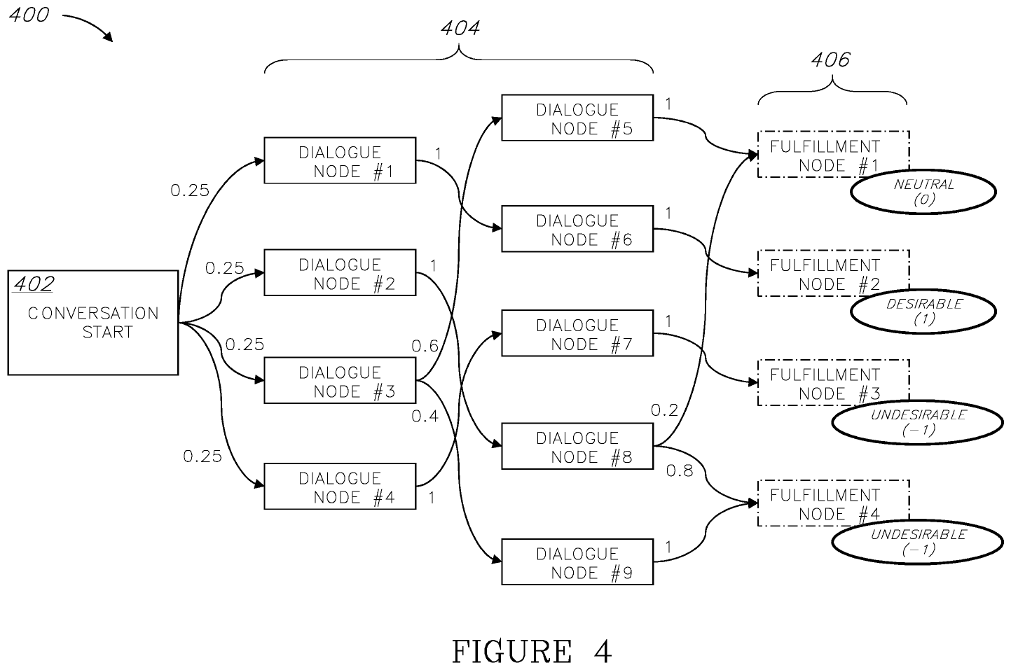

An overview of the functional steps in a method for automated evaluation of human-computer conversations is provided with reference to the flowchart in FIG. 2, and the schematic conversational flows in FIGS. 3 and 4.

FIG. 2, accordingly, is a flow chart of a method 200 for automated evaluation of human-computer conversations. Method 200 may include a number of input steps: Step 202 of accessing data of a conversational computer program, step 204 of obtaining a desirability score of fulfillment nodes of the conversational computer program, and step 206 of obtaining historical data of human-computer conversations carried out by the conversational computer program. Both of steps 202 and 206, however, do not necessarily need to be performed—one may be sufficient. This is discussed in further detail below.

In step 202, the data of the conversational computer program may be accessed, for example, through an API of the program. One or more of the following pieces of data may be retrieved: (a) The entire directed graph of all possible conversational flows according to which the conversational computer program is programmed to operate, or parts of that directed graph (referred to hereinafter as a “programmed conversational flow”); (b) Historical directed graphs of actual conversational flows that took place and were logged in a memory. Namely, the automated evaluation of human-computer conversations may be based on a programmed conversational flow, on historical conversational flows, or on both. It should be noted that the term “directed graph” does not mean that any visual data has to be obtained. Rather, the directed graph may be in the form of computer code, such as an XML (Extensible Markup Language) file or the like, which textually represents the graph. This is known in the art.

An exemplary directed graph 300, representative of a conversational flow, is shown in FIG. 3. As the conversation starts 302, various paths throughout dialogue nodes 304 and fulfillment nodes 306 may be traversed, according to the human user's questions and answers to the computer and the computer's respective determinations. The administrator's scoring of the various fulfillment nodes 306, received in step 204 of FIG. 2, is shown in ellipses next to these nodes: neutral, desirable, and undesirable. Different score types are possible, such as textual scores as shown in the figure or numerical scores, e.g. 0, 1, and −1 for neutral, desirable, and undesirable, respectively. This is, of course, a very simplistic conversational flow. In reality, a conversational flow evaluated by the present invention may include dozens, hundreds, or even thousands of nodes.

The historical data obtained in 206 may refer to past executions of conversations by the conversational computer program. The historical data may include the exact nodes traversed during those conversations, and the order of traversal. For example, with reference to the conversational flow of FIG. 3, a historical record of a single conversation may be: {Conversation Start>Dialogue Node #2>Dialogue Node #8>Fulfillment Node #1}.

Once data has been obtained in steps 202, 204, and 206 (which may be performed simultaneously or in any sequence), its evaluation 208 begins. The evaluation 208 may end with an automatic assignment 210 of a polarity score to each of at least some of the dialogue nodes 304 (FIG. 3). This may be performed by backpropagating the desirability scores of the fulfillment nodes 306 (FIG. 3) to those dialogue nodes that precede them.

For example, since fulfillment node #2 has been manually scored as “desirable”, its preceding dialogue nodes, #6 and #1, will be assigned with a relatively positive polarity score. In this example, because the only possible conversational path between the conversation start 302 and fulfillment node #2 is through dialogue nodes, #1 and #6 (in that order), then both of these dialogue nodes may be assigned with the same polarity score, e.g., 1.

In another scenario, where fulfillment node #4 has been manually scored as “undesirable”, its preceding dialogue nodes, #8, #9, #2, and #3, will be assigned with differing polarity scores because not all of them necessarily lead to fulfillment node #4. Namely, dialogue node #8 can lead either to fulfillment node #4 which is “undesirable”, or to fulfillment node #1 which is “neutral”; dialogue node #3 can lead either to dialogue node #9 (which must lead directly to fulfillment node #4) or to dialogue node #5 (which must lead directly to fulfillment node #1, which is “neutral”).

In sum, when such non-deterministic conversational paths are involved: (a) the effect of a fulfillment node's desirability score will backpropagate more strongly to preceding dialogue nodes which can only lead to that fulfillment node, and (b) effect of a fulfillment node's desirability score will backpropagate more weakly to preceding dialogue nodes which can lead to one or more other fulfillment nodes.

FIG. 4 illustrates this. Its conversation path 400, similar to FIG. 3, starts at a block 402 and traverses dialogue nodes 404 through to fulfillment nodes 406. The edges between the various nodes are labeled with their probabilities. For example, as the conversation starts 402, there is equal probability (0.25) that each of dialogue nodes #1-4 will occur, and so on and so forth.

Backpropagation in the exemplary FIG. 4 may take place according to the following table, in which: (a) only the polarity scores of dialogue nodes #1 and #2 are explained, because they are representative of how the scores are calculated, and (b) for simplicity of discussion, the desirability scores “desirable,” “neutral,” and “undesirable” are assigned with numerical values 1, 0, and −1, respectively.

TABLE 1
Backpropagation of scores from fulfillment nodes to dialogue nodes

| | Assigned | |
|---|---|---|
| Dialogue | Polarity | |
| Node | Score | Manner of Calculation |
| 1 | 1 | Since dialogue node #1 leads to dialogue node #6 with a |
| | | probability of 1 (100%), and dialogue node #6 leads to |
| | | fulfillment node #2 also with a probability of 1, then the |
| | | “desirable” (1) score of fulfillment node #1 propagates fully |
| | | to dialogue node #1. |
| | | The calculation is 1 × 1 × 1 = 1. |
| 2 | −0.8 | Since dialogue node #2 leads to dialogue node #8 with a |
| | | probability of 1, it will be assigned the same polarity score as |
| | | dialogue node #8. And since dialogue node #8 leads to |
| | | fulfillment node #1 with a probability of 0.2 and to fulfillment |
| | | node #4 with a probability of 0.8, then the “neutral” (0) score |
| | | of fulfillment node #1 propagates with a strength of 0.2 to |
| | | dialogue node #8 and the “undesirable” (−1) score of |
| | | fulfillment node #4 propagates with a strength of 0.8 to |
| | | dialogue node #8. |
| | | The calculation is ((0 × 0.2) + (−1 × 0.8)) × 1 = −0.8. |

As more and more historical data of past conversations is gathered, the probable paths of conversation towards desirable, undesirable, and neutral fulfillment nodes may be learned, automatically. With reference to FIG. 4, the probability labels of the edges may change over time, and therefore also the weighed probabilities of entire paths that traverse multiple dialogue nodes towards a fulfillment node. The polarity scores of the dialogue nodes may then be updated based on the learned probable paths, under the premise that dialogue nodes that lead more often to a certain type of fulfillment node (e.g., desirable, undesirable, neutral) should be scored accordingly with this tendency.

Although the term “probability” (e.g., in “probable paths,” “probability labels,” etc.) has been used above in its statistical sense, some alternative embodiments may be based on one or more other techniques for deciding how to backpropagate desirability scores to preceding dialogue nodes. For example, the conversational flow may be modeled as a Markov model, as known in the art. Markov models are stochastic models typically used to model randomly-changing systems. Types of Markov models include Markov chains, hidden Markov models, Markov decision processes, partially-observable Markov decision processes, Markov random fields, hierarchical Markov models, and tolerant Markov models. Those of skill in the art will readily recognize on how to Markov-model the gathered historical data.

As another example, the backpropagation may be based on applying a machine learning classifier to predict the outcome (namely, the occurrence of a fulfillment node) of a certain dialogue node, or of a chain of subsequent dialogue nodes. To this end, historical data in which the fulfillment nodes are labeled may serve as a training set for the machine learning model. Following such supervised training, the classifier may be applied to a newly-received conversation flow, to determine the polarity scores of its dialogue nodes.

More generally, any technique for determining polarity scores of dialogue nodes based on a later-occurring fulfillment node is explicitly intended herein.

Optionally, the conversational computer program itself may be enhanced by the automatically-assigned polarity scores of the dialogue nodes, and/or by the manually-assigned desirability scores of the fulfillment nodes. Undesirable conversational flows may be identified and corrected, to increase the chances of future conversations being successful (e.g., leading to more desirable fulfillment nodes, to greater user satisfaction, etc.). For example, an order of a planned conversational flow that is programmed into the conversational computer program may be altered based on the polarity scores and/or the desirability scores. For example, the flow may be altered to improve (e.g., change the phrasing of) dialogue nodes that too often fail to lead to desirable fulfillment nodes, or even omit completely such dialogue nodes.

Following is an example of how the conversational computer program itself may be enhanced by the automatically-assigned polarity scores of the dialogue nodes, and/or by the manually-assigned desirability scores of the fulfillment nodes. Historical conversational flows may be represented as a model which, together with additional input provided by the user about possible actions (e.g., alternative flows, alternative arrangements, alternative textual responses) and the effect of these actions on the conversational flows, is then fed to an optimization algorithm, such as a state-action-reward-state-action (SARSA) algorithm, in order to examine alternative arrangements of the directed graph (arrangements which conform to allowable actions, defined by the user) in a way that will maximize the overall reward from occurrence of fulfillment nodes. For example, the SARSA algorithm may be applied in the framework of reinforcement learning or a Markov Decision Process (MDP). The output of such reinforcement learning or MDP may include one or more of the following: adding directed edges between nodes, removing directed edges between nodes, reversing the direction of directed edges between nodes, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of a numerical range should be considered to have specifically disclosed all the possible subranges as well as individual numerical values within that range. For example, description of a range from 1 to 6 should be considered to have specifically disclosed subranges such as from 1 to 3, from 1 to 4, from 1 to 5, from 2 to 4, from 2 to 6, from 3 to 6 etc., as well as individual numbers and fractions within that range, for example, 1, 1.5, 2, 2.05, 3, 4, 5, and 6. This applies regardless of the breadth of the range.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising using at least one hardware processor for:
accessing one or more conversational flows of a conversational computer program, wherein the one or more conversational flows each comprises dialogue nodes and fulfillment nodes, and wherein each of the one or more conversational flows is at least one of: (a) a historical conversational flow of a human-computer conversation carried out by the conversational computer program, and (b) a programmed conversational flow, according to which the conversational computer program conducts human-computer conversations;
receiving a desirability score of each of at least some of the fulfillment nodes; and
based on the one or more conversational flows and the desirability scores, automatically assigning a polarity score to each of at least some of the dialogue nodes.

2. The method according to claim 1, wherein:
the fulfillment nodes represent certain actions fulfilled outside of the conversational computer program; and
the dialogue nodes represent messages between the computer and a human user of the computer, wherein the messages do not include said fulfilled certain actions.

3. The method according to claim 2, wherein the certain actions outside of the conversational computer program are selected from the group consisting of:
adding or removing an item to an e-commerce shopping cart on behalf of the user; and
completing an e-commerce purchase on behalf of the user.

4. The method according to claim 2, wherein the desirability score is a numerical of textual value representative of a range from desirable to undesirable.

5. The method according to claim 2, wherein the polarity scores are numerical or textual values representative of a range from positive to negative.

6. The method according to claim 2, wherein the automatic assignment of the polarity scores includes backpropagating the desirability score of each of at least some of the fulfillment nodes to one or more of the dialogue nodes that precede that fulfillment node.

7. The method according to claim 6, further comprising:
obtaining additional historical data of multiple human-computer conversations carried out by the conversational computer program; and
updating the polarity scores of at least some of the dialogue nodes based on probable paths of conversation learned from the additional historical data.

8. The method according to claim 1, further comprising:
altering an order of a planned conversational flow of the conversational computer program, based on at least one of: the desirability scores, and the polarity scores; and
executing the conversational computer program to automatically converse with a human user based on the altered order of the planned conversational flow.

9. The method according to claim 1, wherein said at least one of (a) and (b) is: (a) and (b).

10. A system comprising:
at least one hardware processor; and
a non-transitory computer-readable storage medium having program instructions stored thereon, the program instructions executable by said at least one hardware processor to:
access one or more conversational flows of a conversational computer program, wherein the one or more conversational flows each comprises dialogue nodes and fulfillment nodes, and wherein each of the one or more conversational flows is at least one of: (a) a historical conversational flow of a human-computer conversation carried out by the conversational computer program, and (b) a programmed conversational flow, according to which the conversational computer program conducts human-computer conversations,
receive a desirability score of each of at least some of the fulfillment nodes, and
based on the one or more conversational flows and the desirability scores, automatically assign a polarity score to each of at least some of the dialogue nodes.

11. The system according to claim 10, wherein:
the fulfillment nodes represent certain actions fulfilled outside of the conversational computer program; and
the dialogue nodes represent messages between the computer and a human user of the computer, wherein the messages do not include said fulfilled certain actions.

12. The system according to claim 11, wherein the certain actions outside of the conversational computer program are selected from the group consisting of:
adding or removing an item to an e-commerce shopping cart on behalf of the user; and
completing an e-commerce purchase on behalf of the user.

13. The system according to claim 11, wherein the desirability score is a numerical of textual value representative of a range from desirable to undesirable.

14. The system according to claim 11, wherein the polarity scores are numerical or textual values representative of a range from positive to negative.

15. The system according to claim 11, wherein the automatic assignment of the polarity scores includes backpropagating the desirability score of each of at least some of the fulfillment nodes to one or more of the dialogue nodes that precede that fulfillment node.

16. The system according to claim 15, wherein the program instructions are further executable by said at least one hardware processor to:
obtain additional historical data of multiple human-computer conversations carried out by the conversational computer program; and
update the polarity scores of at least some of the dialogue nodes based on probable paths of conversation learned from the additional historical data.

17. The system according to claim 10, wherein the program instructions are further executable by said at least one hardware processor to:
alter an order of a planned conversational flow of the conversational computer program, based on at least one of: the desirability scores, and the polarity scores; and
execute the conversational computer program to automatically converse with a human user based on the altered order of the planned conversational flow.

18. The system according to claim 10, wherein said at least one of (a) and (b) is: (a) and (b).

19. A computer program product comprising a non-transitory computer-readable storage medium having program instructions embodied therewith, the program instructions executable by at least one hardware processor to:
access one or more conversational flows of a conversational computer program, wherein the one or more conversational flows each comprises dialogue nodes and fulfillment nodes, and wherein each of the one or more conversational flows is at least one of: (a) a historical conversational flow of a human-computer conversation carried out by the conversational computer program, and (b) a programmed conversational flow, according to which the conversational computer program conducts human-computer conversations;
receive a desirability score of each of at least some of the fulfillment nodes; and
based on the one or more conversational flows and the desirability scores, automatically assign a polarity score to each of at least some of the dialogue nodes.

20. The computer program product according to claim 19, wherein:
the fulfillment nodes represent certain actions fulfilled outside of the conversational computer program; and
the dialogue nodes represent messages between the computer and a human user of the computer, wherein the messages do not include said fulfilled certain actions.
